(19) United States
(12) Patent Application Publication
(10) Pub. No.: US 2026/0065601 A1
(43) Pub. Date: Mar. 5, 2026

(54) DYNAMIC AUGMENTED REALITY WEB VIEWING

(71) Applicant: FMR LLC, Boston, MA (US)

(72) Inventors: David Martin, Natick, MA (US); Jamie Barras, Apex, NC (US); Hangyu Wang, Cary, NC (US); Jason McEvoy, Co. Wicklow (IE)

(21) Appl. No.: 18/818,041

(22) Filed: Aug. 28, 2024

(51) Int. Cl. G06T 19/00

(52) U.S. Cl. CPC G06T 19/006

(57) ABSTRACT

A computerized method is provided for augmenting web pages and other content displayed on a traditional monitor with content in an AR environment. In various embodiments, a user can interact with objects in the AR environment to trigger changes to content or objects in the traditionally displayed content on the monitor. In some embodiments, the traditionally displayed content can automatically trigger AR supplementation or may detect private or sensitive information and automatically transfer that information from the traditional display to the AR environment to prevent unwanted viewing by third-parties.

### TECHNICAL FIELD

This application relates generally to systems, methods and apparatuses, including computer program products, for augmenting traditional computer display viewing with augmented reality components.

### BACKGROUND

The advent of augmented (AR) and virtual reality (VR) and the associated controllers and headsets, offer new experiences and modes of interaction for users. Primarily, these devices are used as gaming platforms or as a way of augmenting interactions with the physical world around a user. For example, AR displays (e.g., headsets or glasses) can overlay pictures or text in the user's otherwise normal field of view of the world around them. Applications include providing supplemental information about real world objects in the user's field of view or displaying virtual objects in a real world setting for the user to interact with in the context of gaming, planning, interior decorating and visualization, communication, and others. VR or AR devices have also been used to create wholly virtual desktops/monitors allowing a user to view a virtual computer monitor of any size, even in remote settings where a traditional large format monitor would be impractical (e.g., a coffee shop or hotel room).

### SUMMARY

Systems and methods of the invention address an unrecognized need to integrate AR content with content displayed on traditional computer monitors, especially in the context of web site viewing. Systems and methods of the invention can allow for detection of sensitive or personal content in document or website and direct that information to the AR display to avoid unintended observation by third parties (e.g., in a public setting). Systems and methods of the invention further permit complex and seamless interactions between the traditional computer monitor and AR displays. For example, an object displayed on the traditional monitor may be selected by a user and moved off the monitor into the AR environment. The object can be manipulated in three dimensions, including editing the object, and then returned to the monitor with any changes or edits then reflected on the traditional display. In some embodiments, multiple objects can be merged in the AR environment with those changes being saved and/or reflected on the traditional monitor display in real time or upon being returned to the monitor display by the user.

In various embodiments, objects can be mirrored between the traditional display and the AR environment or one display modality may be used to supplement the other. For example, selection of a traditional statistical graph on a traditional monitor may trigger a three-dimensional representation of that data in the AR environment that can be manipulated by the user and may provide additional or supplemental information.

The AR system may include cameras or other input devices in order to model the user's real-world environment. For example, the AR system can locate a traditional monitor being used by the user in order to track the user's interactions with the traditional monitor (as discussed above) and to coordinate objects in the AR environment so as not to interfere with the user's view of the traditional monitor. In some embodiments, the AR system can use cameras or other input sensors (e.g., gloves on the user's hands) to track movement of the user's eyes or hands in order to allow the user to interact with the monitor and/or objects displayed on the monitor or in the AR environment using their hands or eyes. The AR system may use a camera or other sensor to detect QR codes or other symbols displayed on the traditional monitor (e.g., on a web browser) indicating the presence of AR-augmented content. That detection can trigger the AR system to display the content or prompt the user accordingly.

In various embodiments, systems and methods of the invention can attribute physical properties to objects (e.g., size, weight, or clasticity) and apply real world physics to the objects when they are rendered in the AR environment. For example, a user may select or drag a balloon or basketball from a traditional monitor. When rendered in the AR environment, the balloon may float upward and the basketball may fall to the ground and bounce back up.

Aspects of the invention can include computerized methods for transacting between a physical display and augmented reality (AR) environment. Methods can include receiving display instructions at a computing system comprising a non-transitory memory in communication with a processor, a physical display, and an AR display; analyzing the display instructions to determine a physical display component and an AR display component; displaying the physical display component on the physical display and the AR component on the AR display; tracking a location of the physical display within an AR environment displayed within the AR display; receiving a first user input at the computing device selecting an object displayed on the physical display: displaying the selected object in the AR environment; receiving a second user input at the computing device editing the selected object in the AR environment; receiving a third user input at the computing device returning the edited object to the physical display from the AR environment; and updating the returned object displayed on the physical display with the edits received in the AR environment.

The analyzing step can include determining private content within the display instructions wherein the augmented reality display component comprises the private content. The private content may include one or more of a password, personally identifiable information (PII), financial information, or private messages.

One or more of the first, second, or third user inputs can be received using an input device. The input device can include a mouse or a keyboard. Methods may further comprise tracking a user appendage within the AR environment in relation to the location of the physical display. One or more of the first, second, or third user inputs can be received based on a motion of the tracked user appendage. Selecting the object may include dragging the object from the physical display, outside a border of the physical display, and into the AR environment. Methods can include coordinating the display of the object between the physical display and the AR display during the dragging step. Returning the object to the physical display from the AR environment can comprise dragging the object from the AR environment, into a border of the physical display, and into the physical display.

Objects can be displayed in the AR environment in a fixed position relative to the physical display. Objects may be duplicated after the selecting step and displayed simultaneously on the physical display and in the AR environment. The duplicated object displayed on the physical display may reflect in real time edits made to the duplicated object displayed in the AR environment. In some embodiments, the duplicated object displayed on the physical display may not reflect edits made to the duplicated object displayed in the AR environment until the object is returned to the physical display from the AR environment. The object can be removed from the physical display after the selecting step and displayed only in the AR environment. Returning the edited object to the physical display from the AR environment can cause the edited object to be displayed on the physical display. Methods may further comprise prompting a user, upon returning the edited object to the physical display, to confirm updating of the object displayed on the physical display with the edits. The display instructions may be obtained from a website. The analyzing step can include identifying tags received from the website indicating the physical display component and the AR display component. In some embodiments, displaying the selected object in the AR environment can include translating the selected object from a two-dimensional object to a three-dimensional object.

In certain aspects, systems of the invention can include a computer system for transacting between a physical display and augmented reality (AR) environment. The system can comprise a computing device comprising a processor and a memory storing instructions that, when executed by the processor, cause the processor to perform a series of steps. Those steps can include receiving display instructions at a computing system comprising a non-transitory memory in communication with a processor, a physical display, and an AR display; analyzing the display instructions to determine a physical display component and an AR display component; displaying the physical display component on the physical display and the AR component on the AR display; tracking a location of the physical display within an AR environment displayed within the AR display; receiving a first user input at the computing device selecting an object displayed on the physical display; displaying the selected object in the AR environment; receiving a second user input at the computing device editing the selected object in the AR environment; receiving a third user input at the computing device returning the edited object to the physical display from the AR environment; and updating the returned object displayed on the physical display with the edits received in the AR environment. In various embodiments systems of the invention can be operable to perform any and all of the aforementioned methods.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for AR augmentation of traditional displays.

FIG. 2 shows an exemplary method for transacting between a physical display and augmented reality (AR) environment.

FIG. 3 shows an exemplary AR display mirroring certain objects from a traditionally displayed webpage.

FIG. 4 shows an exemplary websocket server architecture for relaying private messages between a web client and an AR device client.

FIG. 5 shows an exemplary transition of an object from a traditional display to an AR environment.

FIG. 6 shows exemplary manipulation of data in the AR space with those changes then being reflected on a traditional display upon user direction.

### DETAILED DESCRIPTION

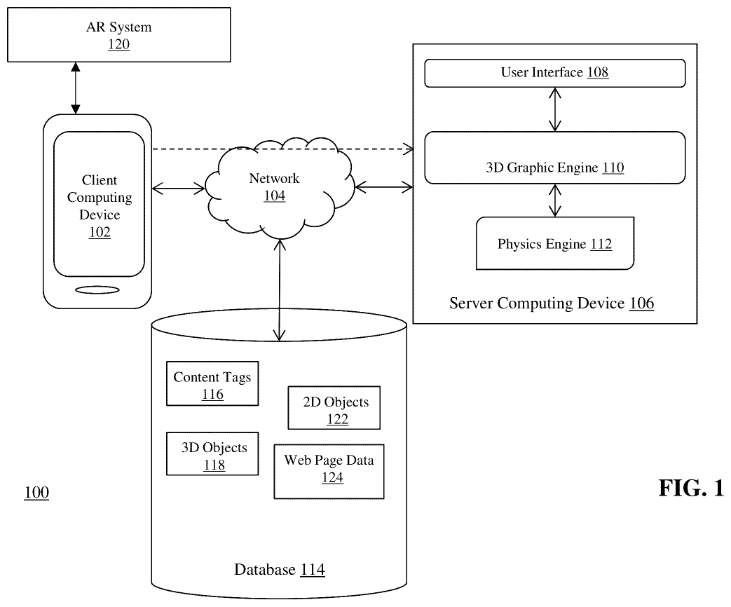

FIG. 1 is a block diagram of an exemplary system 100 for AR augmentation of websites and other documents, files, or objects displayed on a traditional monitor. The system 100 includes a client computing device 102; a communications network 104; a server computing device 106 that includes a user interface module 108, a 3D graphics engine 110, and a physics engine 112; a database 114 that includes a content tags 116, 3D (118) and 2D (122) objects, and web page data 124; and an AR system 120.

The client computing device 102 connects to one or more communications networks (e.g., network 104) in order to communicate with the server computing device 106 to provide input and receive output relating to a website, document, or file that the user is accessing. Exemplary client computing devices 102 include but are not limited to server computing devices, desktop computers, laptop computers, tablets, mobile devices, smartphones, and the like. Typically, the client computing device 102 includes a display device (not shown) that is embedded in and/or coupled to the client computing device for the purpose of displaying information to a user of the device. It should be appreciated that other types of computing devices that are capable of connecting to the components of the system 100 can be used without departing from the scope of invention. Although FIG. 1 depicts one client computing device 102, it should be appreciated that the system 100 can include any number of client computing devices. The client computer device can be in communication with one or more input/output devices including AR systems 120. AR systems 120 cand include headsets or glasses operable to overlay virtual objects or images onto the user's real world view. Such headsets may be partially transparent or may completely obstruct the user's view of their environment, replicating that view through the use of cameras and stereo displays to allow for the imposition of virtual objects thereupon.

AR systems 120 may include one or more hand position sensors 120. Such sensors can include a camera, an infrared camera, and/or a light emitting diode. The sensors 120 can be incorporated into, for example, a VR or AR headset worn by the user. Exemplary hand tracking devices are available from, for example, Ultralcap Limited (Bristol, UK). In various embodiments, the one or more sensors 120 can be located on the at least one hand. Exemplary hand position sensors 120 including wearable sensors are discussed by Chen, et al., A Survey on Hand Pose Estimation with Wearable Sensors and Computer-Vision-Based Methods, Sensors. 2020; 20 (4):1074.https://doi.org/10.3390/s2004107, incorporated herein by reference.

In some embodiments, the client computing device 102 can execute one or more software applications that are used to provide input to and receive output from the server computing device 106. For example, the client computing device 102 can be configured to execute one or more native applications and/or one or more browser applications. Generally, a native application is a software application (in some cases, called an ‘app’) that is installed locally on the client computing device 102 and written with programmatic code designed to interact with an operating system that is native to the client computing device 102. Such software may be available from, e.g., the Apple® App Store, the Google® Play Store, the Microsoft® Store, or other software download platforms depending upon, e.g., the type of device used. In some embodiments, the native application includes a software development kit (SDK) module that is executed by a processor of the client computing device 102 to perform functions associated with 3D environments, hand tracking, and/or user authentication. Generally, a browser application comprises software executing on a processor of the client computing device 102 that enables the client computing device to communicate via HTTP or HTTPS with remote servers addressable with URLs (e.g., server computing device 106) to receive website-related content, including one or more webpages, for rendering in the browser application and presentation on the display device coupled to the client computing device 102 such as a traditional monitor and/or an AR headset. Exemplary mobile browser application software includes, but is not limited to, Firefox™, Chrome™, Safari™, and other similar software. The one or more webpages can comprise visual and audio content for display to and interaction with a user.

The communications network 104 enables the client computing device 102 to communicate with the server computing device 106. The network 104 is typically comprised of one or more wide area networks, such as the Internet and/or a cellular network, and/or local area networks. In some embodiments, the network 104 is comprised of several discrete networks and/or sub-networks (e.g., cellular to Internet).

The server computing device 106 is a device including specialized hardware and/or software modules that execute on a processor and interact with memory modules of the server computing device 106, to receive data from other components of the system 100, transmit data to other components of the system 100, and perform functions for AR augmentation of traditionally displayed objects, files, webpages, and more. The server computing device 106 includes a user interface module 108, a 3D graphics engine 110, and a physics engine 112 that execute on the processor of the server computing device 106. In some embodiments, the modules 108, 110, and 112 are specialized sets of computer software instructions programmed onto one or more dedicated processors in the server computing device 106 and can include specifically designated memory locations and/or registers for executing the specialized computer software instructions.

The user interface 108 can provide prompts to the user regarding the availability of AR content related to, for example, a graphic or other portion of a web page being viewed by the user on a traditional monitor. The user interface 108 may also facilitate editing of 3D objects in an AR environment and the effect that might have on 2D renderings of those objects (e.g., save prompts). In some embodiments, the user interface 108 may allow the user to toggle real world physics or other features of their AR environment or objects displayed therein. The 3D graphic engine 110 can allow the hand-tracking information from the sensor 120 to be processed into a 3D environment 112 to allow the user to interact with 3D objects in the AR environment. The 3D graphic engine 110 may also generate or render 3D graphics or objects in the AR environment. Exemplary 3D graphics environments or engines 110 can include, for example, Unity, Unreal Engine, or WebGL. The physics engine 112 can apply real world physics to objects rendered in the AR environment. For example, how a basketball or balloon object in the AR environment may behave relative to that environment (e.g., floating, sinking, or bouncing).

Although the computing modules 108, 110, and 112 are shown in FIG. 1 as executing within the same server computing device 106, in some embodiments the functionality of the computing modules 108, 110, and 112 can be distributed among a plurality of server computing devices. As shown in FIG. 1, the server computing device 106 enables the computing modules 108, 110, and 112 to communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. The exemplary functionality of the computing modules 108, 110, and 112 is described in detail throughout this specification.

The database 114 is a computing device (or in some embodiments, a set of computing devices) coupled to the server computing device 106 (in some embodiments, via communications network 104) and is configured to receive, generate, and store specific segments of data relating to the process AR augmentation and transacting in the AR space and between the AR space and a traditional monitor. In some embodiments, all or a portion of the database 114 can be integrated with the server computing device 106 or be located on a separate computing device or devices. The database 114 can comprise one or more databases configured to store portions of data used by the other components of the system 100, as will be described in greater detail below.

In some embodiments, the database 114 comprises a set of content tags 116 associated with, for example, a webpage. Generally, the content tags 116 are accessed and displayed by the webpage and detected by the AR system. The content tags 116 are associated with specific AR content that may supplement the webpage information appearing on a traditional monitor. That web page data 124 can be stored on and accessed from the database 114. Exemplary AR content can include 2D objects 122 and 3D objects 118 that may be accessed by the AR system and displayed. Upon detecting a tag, the AR system may submit the tag to the server computing device 106 from which the webpage is being managed and, in turn, may be supplied with the AR content linked to the tag. In some embodiments, a user may view a 2D object from the 2D objects 122 in the database on a traditional monitor and, upon selecting the object (e.g., through virtually “touching” and “dragging” the object from the monitor into the AR environment surrounding the monitor) a corresponding 3D version of the object may be obtained and displayed from the 3D objects 118 database.

In various embodiments the user may edit the 3D object in the AR environment using an input device including, for example, their hands. For example, the user may rotate, resize, recolor, draw on, crop, or otherwise edit the 3D object through established finger and/or hand motions such as bringing their pointer finger and thumb closer together or farther apart. The 3D graphic engine 110 may be used to translate 2D objects into 3D objects and vice versa. In some embodiments, the edits made to a 3D object may be saved in the 3D objects 118 database in real time, after prompting from the user, or through user input such as “dragging” the object back from the AR environment into the traditional monitor. Edits to the 3D object can be reflected on a 2D version of that object and saved in the 2D objects 122 database and created, for example, using the 3D graphic engine 110. That 2D object can be updated and saved in real time during AR edits or may be updated only upon prompting or input from the user as discussed above.

While the architecture depicted in FIG. 1 may be applied to, for example, webapp embodiments, it should be appreciated that different architectures may be employed within the contemplated scope of the invention. For example, instead of a 3D Graphics Engine 110, User Interface 108, and physics engine 112 being present in a server 106 with the client 102 acting as a presentation layer, in certain non-browser use cases such as native mobile, XR, and desktop applications, those components may be distributed differently. In such scenarios any or all of the 3D graphics Engine 110, User Interface 108, and physics engine 112 may be integrated in the client 102.

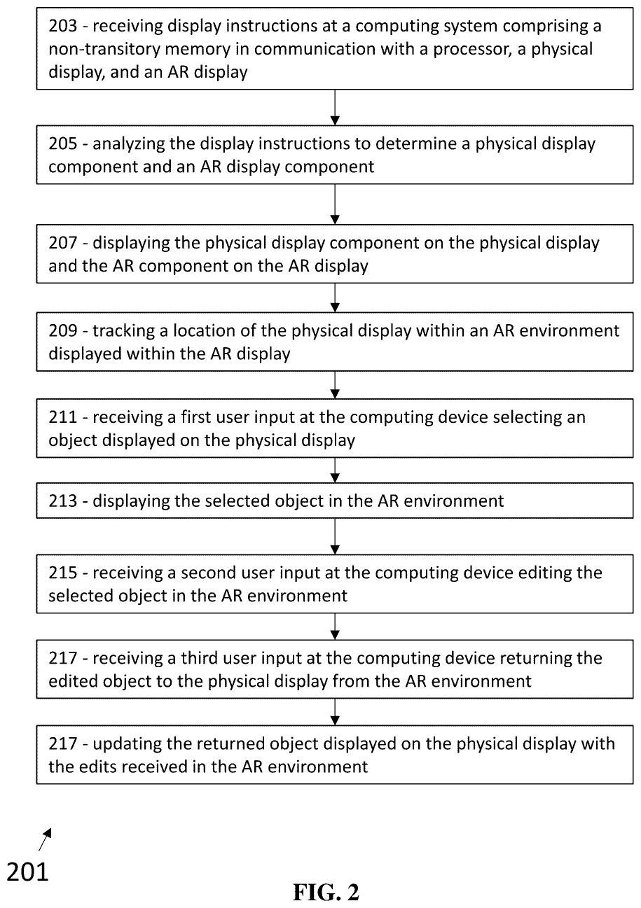

FIG. 2 shows an exemplary method 201 for transacting between a physical display and augmented reality (AR) environment including receiving 203, display instructions at a computing system comprising a non-transitory memory in communication with a processor, a physical display, and an AR display. Methods can then include analyzing 205 the display instructions to determine a physical display component and an AR display component.

The physical display component can then be displayed 207 on the physical display and the AR component can be displayed 207 on the AR display. The location of the physical display can be tracked 209 within the AR environment displayed on the AR display. A first user input can be received 211 at the computing device selecting an object displayed on the physical display. The selected object can then be displayed 213 in the AR environment. The computing device can received 215 a second user input editing the selected object in the AR environment and receive 217 a third user input returning the edited object to the physical display from the AR environment. The returned object displayed on the physical display can be updated 217 with the edits received in the AR environment.

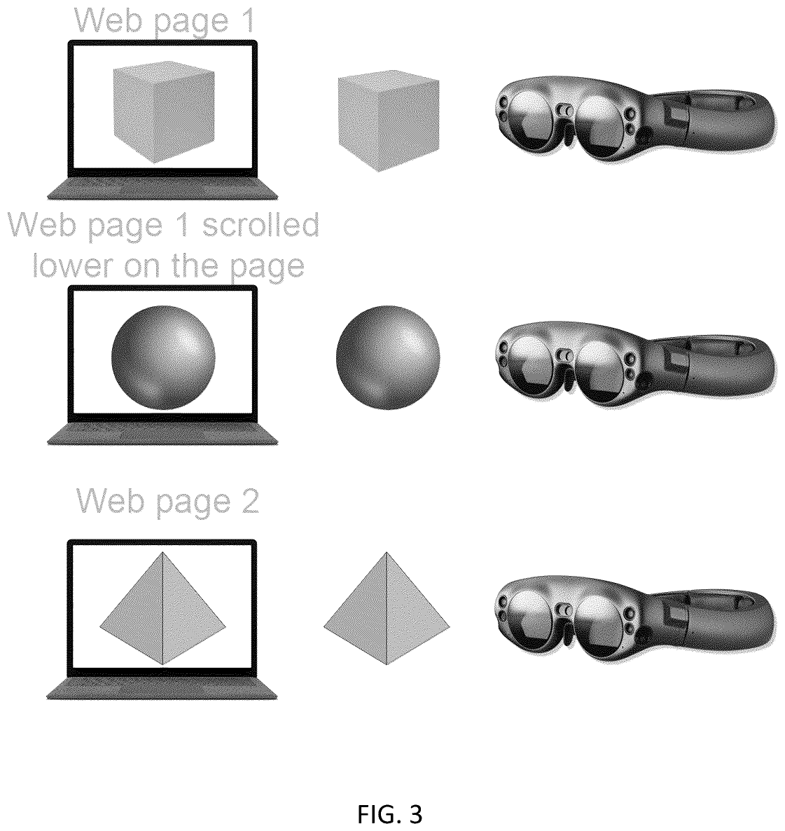

In certain embodiments, systems and methods of the invention may be used for AR enhanced viewing or experiences with webpages. For example, when loading a web page, the web page may send unique tags (for that page) to a remote user's computer device which may include an AR system and/or a traditional monitor. The system can communicate with the AR system's headset or glasses and the AR glasses can display curated addition content through the AR glasses that is associated with the unique tags. When moving to another web page (or another place on the web page), new unique tags can be sent, changing the content in the AR display. Additionally, the AR system, as noted, can send messages back to the web page, changing the web page as well. An exemplary system is depicted in FIG. 3 in which an AR headset displays various mirrored objects in an AR environment as a user scrolls through a first webpage and accesses a second webpage.

As noted, the AR system can map the location or a laptop or traditional monitor and shape within the AR environment so that any AR content displayed isn't blocking the web page and, in some embodiments, so that the AR content may interact with the traditional monitor. For example, the application may locate the monitor and, when something displayed on a left column of the traditionally displayed webpage triggers an AR event, then that content may pop out to the left hand side of the screen, appearing to emerge from the monitor.

In some embodiments, the AR system may detect secure content such as login prompts, personally identifiable information, medical or financial information on a traditionally displayed webpage. The system may immediately divert that information to the AR environment to avoid unwanted third-party viewing. The system may also offer the user the option to move that information to the AR environment or otherwise prompt the user before making the shift.

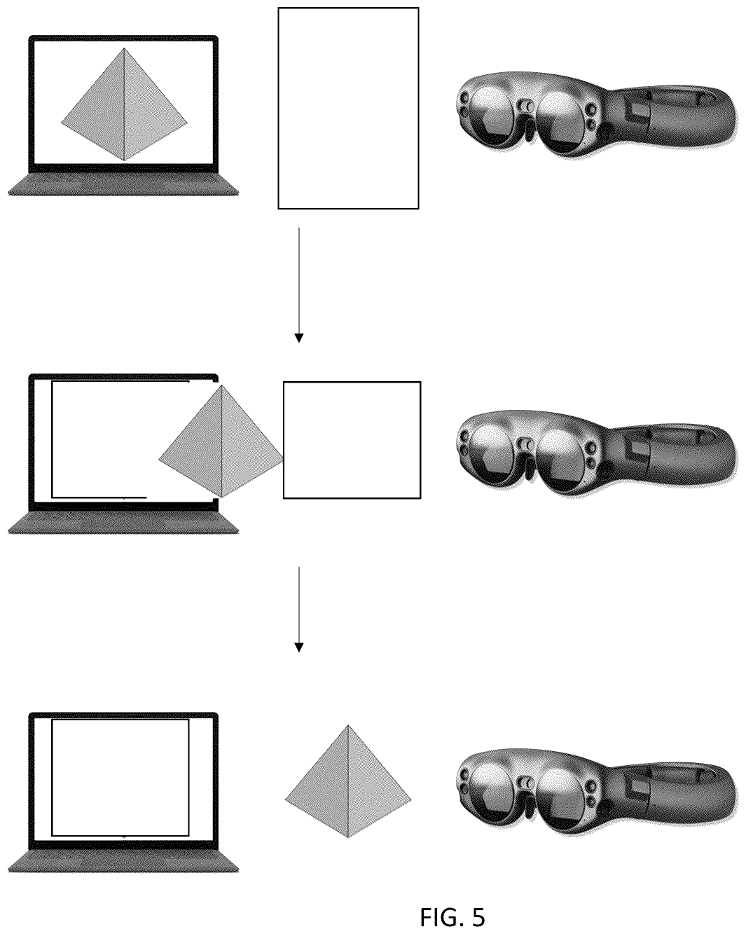

As discussed above, in various embodiments, AR objects may be manipulated in the AR environment with that manipulation (e.g., positioning or editing) triggering actions including changes to the webpage or other content displayed on the traditional monitor. In certain embodiments, a user may select an object displayed on the traditional monitor such as a graph or chart. Selecting the object may entail the user gesturing to the object with their hand with that gesture being sensed by the AR system. In some embodiments, the object may be selected using a keyboard, mouse, or other traditional input device. The user may use an AR or traditional input device to drag the object to and off of the edge of the traditional monitor. The AR system, having mapped the traditional monitor, may seamlessly render a 3D version of the object in the AR environment as the 2D object is dragged off of the display. Such an embodiment is depicted in FIG. 5 where a user has selected the green triangle on the laptop monitor and drags it off the screen as it appears in the AR environment rendered by the user's AR glasses. In other embodiments, the object may remain on the traditional monitor and simply be replicated in the AR environment.

The user may then interact with the AR object. For example, the AR system, using known input methods such as hand tracking, can allow the user to reposition, resize, or otherwise edit the AR object using their hands and/or fingers. In some embodiments, the user may select multiple AR objects (e.g., by “grasping” a different AR objects with each of their two hands) and combine them by using their hands to bring the two objects together. For example, a user may add data from one chart to another chart using such a method.

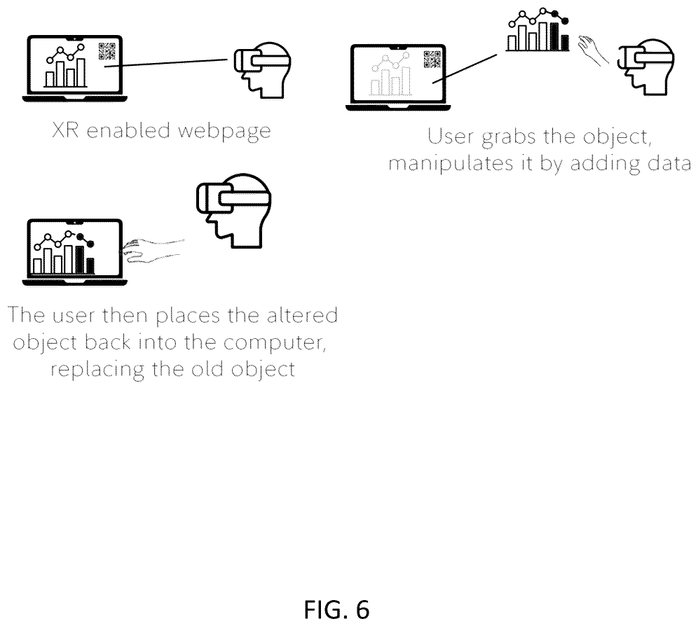

In various embodiments, the changes made by a user to the object can be reflected in the 2D environment of the traditional monitor. For example, a secure login displayed in the AR environment may trigger access to content on the traditional monitor. In other examples, a user may edit a 3D representation of a graph in the AR environment and that change may be reflected in a 2D representation of that same data on the traditional monitor. Those changes may be reflected in real time or triggered by user input. In some embodiments, the user may trigger updating or saving of changes to an object by “dragging” that object from the AR environment back onto the traditional display. Such an example is shown in FIG. 6. In some embodiments, the user may interact with the website by selecting a hyperlink or other object on the traditional display or even by voice command to trigger a more detailed or otherwise related graphic to be displayed in the AR environment. The use of an AR environment can allow for greater detail to be displayed. For example, visiting a financial services webpage, a user may request information on a particular sector. That request can trigger a chart or graphic to be displayed in the AR environment with in-depth detail about the performance of stocks in that sector. The user may then interact with the graphic to, for example, focus on a particular company, a certain date range, a certain exchange, or any other aspect of the data for more information. As the user interacts with the AR graphic, their actions may in turn trigger changes on the traditional monitor, for example an enquiry about a certain company in the target sector on the AR graphic may trigger a browser to open that company's website on the traditional monitor.

In various embodiments, AR environments may be determined and rendered using plane detection. Plane detection can be used to identify an area in the AR environment that represents the traditional monitor. For example, ARKit/ARCore SDKs may be used within a 3d game engine such as Unity to detect planes. This can be done by adding a Plane Detection script to the AR Camera. Once a plane is detected, a monitor location prefab can be created at the desired location. This prefab can consist of a trigger volume that can trigger the return of edited data to a web client via a websocket connection as detailed below.

Exemplary code for creating a prefab space for the traditional monitor is included below. Once the space is created, plane detection can be turned off.

```
  void Update( )
    {
      // Check if new planes have been detected
      int numPlanes = m_PlaneManager.GetCurrentPlaneCount( );
      for (int i = 0; i < numPlanes; i++)
      {
        var plane = m_PlaneManager.GetCurrentPlane(i);
        // Check if the plane is valid and horizontal
        if (plane.alignment == UnityARAlignment.Horizontal && plane.extents.x > 0.5f
&& plane.extents.z > 0.5f)
        {
          // Check if a prefab has been placed on the plane
          if (m_PlacedPrefab == null)
          {
            // Wait for user input to place the prefab
            if (EnhancedTouch.touchCount > 0 && EnhancedTouch.GetTouch(0).phase
== TouchPhase.Began)
            {
              // Create a new GameObject for the prefab
              placedPrefab = Instantiate(monitorPrefab, Vector3.zero,
Quaternion.identity);
              // Disable plane detection
              m_PlaneManager.enabled = false;
            }
          }
        }
      }
    }
```

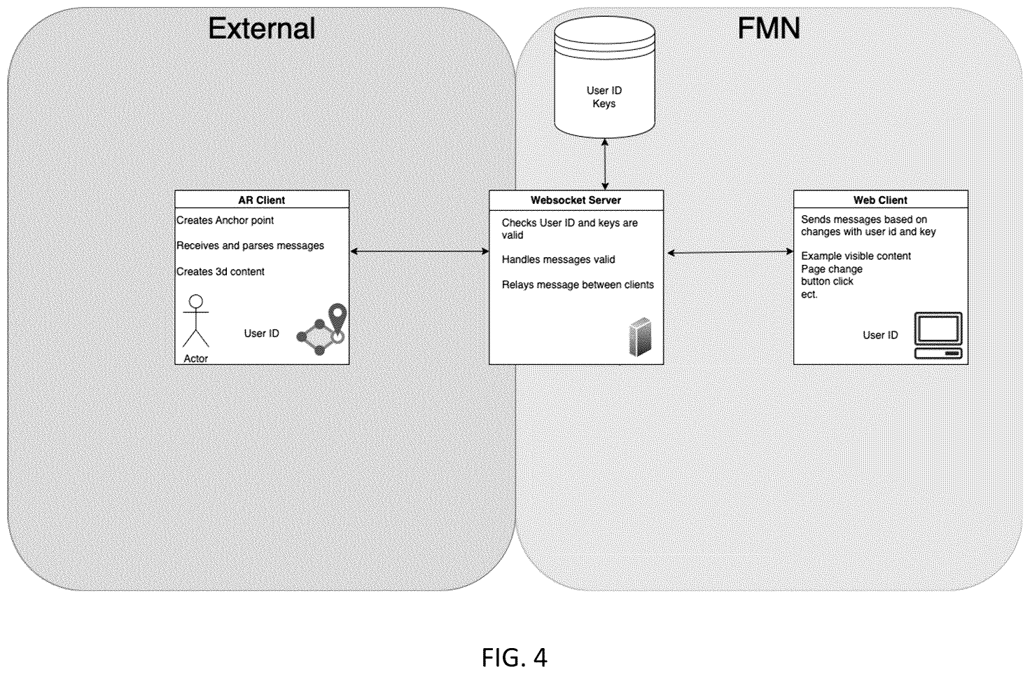

In certain embodiments, a websocket server may be used to relay private messages between a web client and an AR Device client to ensure security of that information during AR augmentation of webpages. FIG. 4 shows an exemplary architecture for this relay. The external AR client creates an anchor point and receives and parses messages from the web client through the websocket server. The AR client creates 3D AR content from the web client. The AR client communicates with the websocket server and provides a user id and keys for authentication. The websocket server accesses user keys stored in a database to authenticate the user and, if valid, relays messages between the internal web client and the external AR client. When the clients start-up they can authenticate to the server with ID and Key. When Messages are sent from clients they also send their ID. This allows the sever to send messages to only the specific client the message is for.

For 3D object editing in the AR environment, when a 3d object is sent to the AR application via websocket from a web client, the data can be manipulated using, for example, a Unity game engine. In the example below, an object called cube has been sent from a web client containing json data such as:

```
{
  Id:6637467836473647367846
  Color: red,
  xScale:1,
  yScale:1,
  zScale: 1
}
```

When the object is created in 3d space there is a cube with scale=Vecter3(1,1,1) and material color=red. The user can then edit the object by, for example, scaling the object with input in AR scene and changing the color to blue:

```
//method to call to change object
  private void ChangeObject(Vector3 targetScale, Color targetColor)
    {
      // Set the object's scale to the target scale
      transform.localScale = Vector3.one * targetScale;
      // Change the material color
      objectRenderer.material.color = targetColor;
    }
```

Merging data, as discussed above, can be performed similarly to editing. As an example of merging AR objects, s user may have two cube objects that have been sent from a web client with metadata as follows:

//Cube with Red as color rgb(1,0,0)
{
XScale = 1,
YScale = 1,
ZScale = 1,
ColorR = 1,
ColorG = 0,
ColorB = 0,
}
//cube with blue as color rgb(0,0,1)
{
XScale = 1,
YScale = 1,
ZScale = 1,
ColorR = 0,
ColorG = 0,
ColorB = 1,
}

A OnTriggerEnter method can be used to receive an event when the cubes have crossed each other and trigger the start of a merge. The system can receive the color and scale values of both objects and then begin the merge.

```
//Merge color values
private Color MergeColors(Color color1, Color color2)
  {
    float r = Mathf.Clamp01((color1.r + color2.r) / 2); // Average R channel value
    float g = Mathf.Clamp01((color1.g + color2.g) / 2); // Average G channel value
    float b = Mathf.Clamp01((color1.b + color2.b) / 2); // Average B channel value
    float a = Mathf.Clamp01((color1.a + color2.a) / 2); // Average A channel value
    return new Color(r, g, b, a); // return new color
  }
//Merge scale values
private Vector3 MergeScales(Vector3 scale1, Vector3 scale2)
  {
    float x = (scale1.x + scale2.x) / 2; // Average X channel value
    float y = (scale1.y + scale2.y) / 2; // Average Y channel value
    float z = (scale1.z + scale2.z) / 2; // Average Z channel value
    return new Vector3(x, y, z);
  }
```

Once the objects' values have been merged, a new instance of the object can be created with new merged values and the previous two independent objects can be removed.

Once an object has been edited in the AR environment (e.g., the merged example above) that object will have a new scale and new color. The user may then move the target object back toward the monitor which may trigger the system to remove the instance displayed in the AR environment and to send the new data related to the edited object back to the web client for storage and/or display on the traditional monitor.

The monitor prefab discussed above can be a volume with a collider to act as a trigger to cause the object to be sent back to the web client after manipulation or editing when the object breaks the plane of the monitor prefab in the AR space. This action can be accomplished as follows in various embodiments:

```
private void OnTriggerEnter(Collider other)
  {
      //if object in volume is sendable
If(other == sendableObject)
{
//wait for input to send
        StartCoroutine(WaitForInput(other.gameobject));
}
  }
  private IEnumerator WaitForInput(Gameobject obj)
  {
    while (!Input.GetKeyDown(inputName))
    {
      yield return null; // Wait for the next frame
    }
    // Input send object new data via websocket as shown in send message of
data = Obj.GetCompoent<CurrentData>( );
websocket section
//change data to json
Jsondata = data.toJson(data)
//send data
  Websocket.instance.SendMessage(Jsondata);
//destroy 3d object
Destroy(obj);
}
```

In some embodiments, the web client may receive new data for sent objected and updates necessary data on the web client. The system can check id of new data to match and update the 2d web client with new data. For example, the image of a cube may now be scaled and color changed.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for transacting between a physical display and augmented reality (AR) environment, the method comprising:
receiving display instructions at a computing system comprising a non-transitory memory in communication with a processor, a physical display, and an AR display;
analyzing the display instructions to determine a physical display component and an AR display component;
displaying the physical display component on the physical display and the AR component on the AR display;
tracking a location of the physical display within an AR environment displayed within the AR display;
receiving a first user input at the computing device selecting an object displayed on the physical display;
displaying the selected object in the AR environment;
receiving a second user input at the computing device editing the selected object in the AR environment;
receiving a third user input at the computing device returning the edited object to the physical display from the AR environment; and
updating the returned object displayed on the physical display with the edits received in the AR environment.

2. The computerized method of claim 1, wherein the analyzing step comprises determining private content within the display instructions wherein the augmented reality display component comprises the private content.

3. The computerized method of claim 2, wherein the private content comprises one or more of a password, personally identifiable information (PII), financial information, or private messages.

4. The computerized method of claim 1, wherein one or more of the first, second, or third user inputs is received using an input device.

5. The computerized method of claim 4, wherein the input device comprises a mouse or a keyboard.

6. The computerized method of claim 1, further comprising tracking a user appendage within the AR environment in relation to the location of the physical display.

7. The computerized method of claim 6, wherein one or more of the first, second, or third user inputs is received based on a motion of the tracked user appendage.

8. The computerized method of claim 1, wherein selecting the object comprises dragging the object from the physical display, outside a border of the physical display, and into the AR environment.

9. The computerized method of claim 8, further comprising coordinating the display of the object between the physical display and the AR display during the dragging step.

10. The computerized method of claim 1, wherein returning the object to the physical display from the AR environment comprises dragging the object from the AR environment, into a border of the physical display, and into the physical display.

11. The computerized method of claim 1, wherein the object is displayed in the AR environment in a fixed position relative to the physical display.

12. The computerized method of claim 1, wherein the object is duplicated after the selecting step and displayed simultaneously on the physical display and in the AR environment.

13. The computerized method of claim 12, wherein the duplicated object displayed on the physical display reflects in real time edits made to the duplicated object displayed in the AR environment.

14. The computerized method of claim 12, wherein the duplicated object displayed on the physical display does not reflect edits made to the duplicated object displayed in the AR environment until the object is returned to the physical display from the AR environment.

15. The computerized method of claim 1, wherein the object is removed from the physical display after the selecting step and displayed only in the AR environment.

16. The computerized method of claim 15, wherein returning the edited object to the physical display from the AR environment displays the edited object on the physical display.

17. The computerized method of claim 16, further comprising prompting a user, upon returning the edited object to the physical display, to confirm updating of the object displayed on the physical display with the edits.

18. The computerized method of claim 1, wherein the display instructions are from a website.

19. The computerized method of claim 18, wherein the analyzing step comprises identifying tags received from the website indicating the physical display component and the AR display component.

20. The computerized method of claim 1, wherein displaying the selected object in the AR environment comprises translating the selected object from a two-dimensional object to a three-dimensional object.
